(19) United States
(12) Patent Application Publication
(10) Pub. No.: US 2005/0150120 A1
(43) Pub. Date: Jul. 14, 2005

(54) Projection device

(76) Inventors: Daniel Bone, Durham (GB); Brian Wadge, Durham (GB)

Correspondence Address: John Yun;Group Patent Counsel, The Black & Decker Corporation, 701 East Joppa Road, Towson, MD, 21286, US

(21) Appl. No.: 10/511,467

(22) PCT Filed: Apr. 16, 2003
(86) PCT No.: PCT/EP03/03952

(30) Foreign Application Priority Data
Apr. 18, 2002 (GB) 0208845.8

(51) Int. Cl. G01C 15/00

(52) U.S. Cl. 33/286

(57) ABSTRACT

A device for projecting an alignment guide (34,36) onto a workpiece comprises a mount (2) for mounting the device on or upon a workpiece and a self levelling projector (12) for projecting the alignment guide (34,36) in a predetermined orientation relative to the vertical. The projector (12) is articulated to the mount (2) so that the alignment guide (34,36) emanates from that point on the workpiece where the mount (2) is situated.

The present invention relates to a device for projecting an alignment guide onto a workpiece, the device comprising:
a mount for mounting the device upon or within the workpiece, upon which workpiece the device is to project the alignment guide;
a self-levelling projector for projecting the alignment guide onto the workpiece in a predetermined orientation relative to the vertical.

Devices of the above type are known for use in the building industry, for example. When a structure such as a wall for the side of a house needs to be constructed, it is important for the wall to be both vertically and horizontally aligned. If the base row of bricks, for example, were laid at an angle to the horizontal, then the entire wall would be built with a horizontal slope. This could be disastrous to the long-term stability of both the wall and the building which it is intended to support.

The known alignment devices, which tend to employ laser optical emitters, can be laid upon the first brick (which is already known to be horizontally aligned) and project a horizontal beam therefrom. This horizontal beam is then used as a reference guide for the laying of the subsequent bricks in that row to ensure they are horizontal.

There are several problems associated with this known type of device, however. One of the greatest problems is that before the device can be accurately used the base position must itself be calibrated relative to a known reference point. In the above example, the first-laid brick must itself be horizontal for the subsequent reference guide to also be horizontal.

Alternatively, even if there is no requirement to first calibrate a device relative to the horizontal, the location of the device itself may be an issue. For example, it may be undesirable to site the device close to the position where work needs to be done as the device may interfere with this work.

Preferred embodiments of the present invention seek to overcome the above disadvantages of the prior art.

According to an aspect of the present invention, there is provided a device for projecting an alignment guide onto a workpiece, the device comprising:
a mount for mounting the device to the workpiece, upon which workpiece the device is to project the alignment guide; and
a self-levelling projector for projecting the alignment guide onto the workpiece in a predetermined orientation relative to the vertical;
the device characterised in that the projector is articulated to the mount in use so that the alignment guide emanates from a point adjacent a substantially horizontal line extending outwards of and through the location on the surface of the workpiece where the mount is situated.

By providing a self-levelling projector which is articulated to the mount in use such that the alignment guide emanates from a point adjacent a substantially horizontal line extending outwards of and through the location of the mount on the surface of the workpiece, this provides the advantage, for example, the location where a hole is to be made in the workpiece to be accurately aligned with an existing hole in the workpiece.

The projector may be articulated to the mount in use so that the alignment guide emanates from that point on the workpiece where the mount is situated.

The projector may be adapted to self-level in a plurality of equilibrium conditions.

The device preferably further comprises a support for the projector, wherein the support is adapted to receive the projector in a plurality of orientations.

This provides the advantage of enabling the device, for example, to project alignment guides which are horizontally and/or vertically aligned with the location of the mount.

In a preferred embodiment, the device further comprises a first body part for supporting the projector and a second body part adapted to engage the first body part in first and second orientations relative thereto to define respective first and second equilibrium conditions.

This provides the advantage of enabling the device to have more than one equilibrium condition, without requiring the projector to be dismounted from the first body part to convert between the first and second equilibrium conditions. This in turn provides the advantage of making the device easier to use, and to be made more robust with fewer demountable components.

The device may further comprise locking means for locking said first and second body parts relative to each other in said first and second orientations.

The first and second body parts are preferably pivotable relative to each other about a first axis between said first and second orientations.

This provides the advantage of avoiding the use of separable first and second body parts, which could become lost.

In a preferred embodiment, the locking means comprises at least one first pivot part provided on one of said first or second body part, and at least one second pivot part provided on the other of said first or second body part, wherein at least one said first pivot part is adapted to be displaced relative to at least one said second pivot part in a direction substantially parallel to said first axis between an unlocked condition in which said first and second body parts are pivotable relative to each other about said first axis, and a locked condition in which said first and second body parts are prevented from pivoting relative to each other.

The first pivot part may comprise a pin having a first portion of substantially circular cross section, and a second portion of non-circular cross section, wherein the second portion is adapted to engage a non-circular aperture in a said second pivot part in the locked condition.

In a preferred embodiment, said second portion is of cross-shaped cross section.

This provides the advantage that the second portion can be arranged to engage the non-circular aperture in more than one orientation, in other words, corresponding to more than one equilibrium condition of the device.

In a preferred embodiment, the first and second body parts are pivotable relative to each other about a second axis, transverse to said first axis, and the device further comprises engaging means for enabling alignment of said first and second body parts in a predetermined orientation relative to each other.

The engaging means preferably comprises at least one respective abutment member provided on said first and/or second body part for engaging the other of said first or second body part.

The second body part is preferably adapted to accommodate a battery for supplying electrical power to the projector.

The device preferably further comprises adjustment means for adjusting the position of the projector relative to the axis of articulation thereof to the mount.

The adjustment means may include a screw thread.

The projector may be adapted to self-level under the influence of gravity.

This means that no external force is needed in order for the projector to find its level.

The projector may act like a pendulum in order to self-level.

The projector is preferably freely rotatable about the mount.

In a preferred embodiment the projector is articulated to the mount via a ball race bearing assembly.

Advantageously the projector may include a laser emitter.

Furthermore the alignment guide may comprise a visible line, lines cross wires or even a grid.

In preferred embodiment the alignment guide is adapted to provide a reference point on the workpiece which is horizontally or vertically aligned with that position on the workpiece where the mount is situated.

The mount may comprise a generally cylindrical projection which is resiliently radially expandable or contractable in order to allow the mount to centre itself in the respective hole, cut or rebate.

The projector is preferably pivotably mounted to the mount about a third axis substantially perpendicular to the axis of articulation thereof to the mount.

This provides the advantage of assisting the device to reach the or each equilibrium condition thereof even if said first axis is not generally horizontal.

The mount may comprise an aperture for engaging an existing fixing on the workpiece.

According to another aspect of the present invention, there is provided a kit of parts for enabling a plurality of aligned holes, cuts or rebates to be formed within a workpiece, the kit of parts comprising:
i) a power tool for forming an initial hole cut or rebate in the workpiece, and;
ii) a device for projecting an alignment guide onto a workpiece, the device comprising:
a mount adapted to be mounted to a workpiece; and
a self-levelling projector for projecting the alignment guide onto the workpiece in a predetermined orientation relative to the vertical;

the device characterised in that the projector is articulated to the mount in use so that the alignment guide emanates from a point adjacent a substantially horizontal line extending outwards of and through the location on the surface of the workpiece where the mount is situated.

Such a kit of parts provides the facility for the projecting device being detachable from the tool so that a hole, cut or rebate may be formed in the workpiece, the projection device placed in such hole, cut or rebate and then the tool following the alignment guide to form the next hole, cut or rebate in a defined position based upon this alignment guide.

Preferably the projecting device is removably retained on or contained within the power tool. This means that the chances of it being lost by being misplaced are reduced.

According to yet a further aspect of the present invention there is provided a method for projecting a self-levelling alignment guide onto a workpiece, the method comprising the steps of:
a) fitting a mount within a cut, hole or rebate, or attaching the mount to a projection, which mount is articulated to a self-levelling projector, and
b) projecting, from the self-levelling projector, an alignment guide onto the workpiece; which alignment guide is projected onto the workpiece in a predetermined orientation relative to the vertical.

The method may further comprise the step of forming said hole, cut or rebate within the workpiece, or attaching a projection thereto.

Preferred embodiments of the inventions will now be described, by way of example only and not in any limitative sense, with reference to the accompanying drawings, in which:

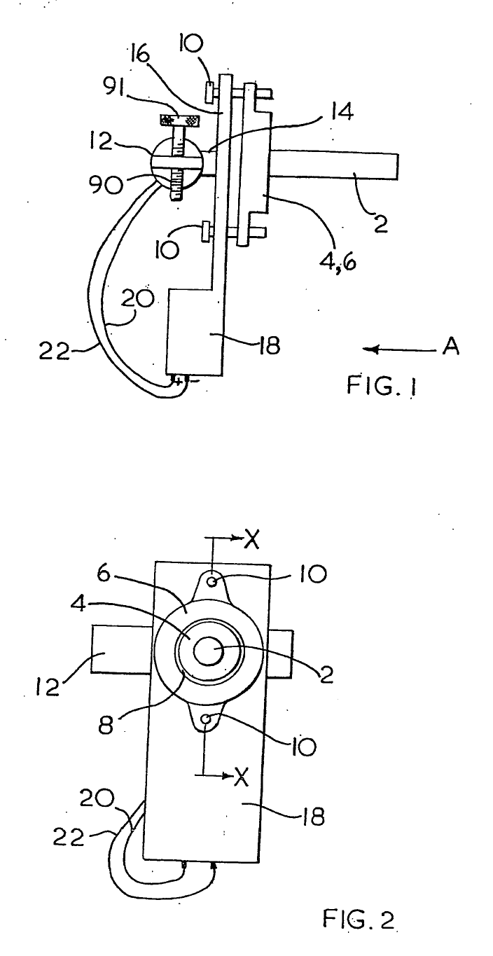

FIG. 1 shows a side view of a device of a first embodiment of the present invention;

FIG. 2 shows an end view in the direction of arrow A in FIG. 1;

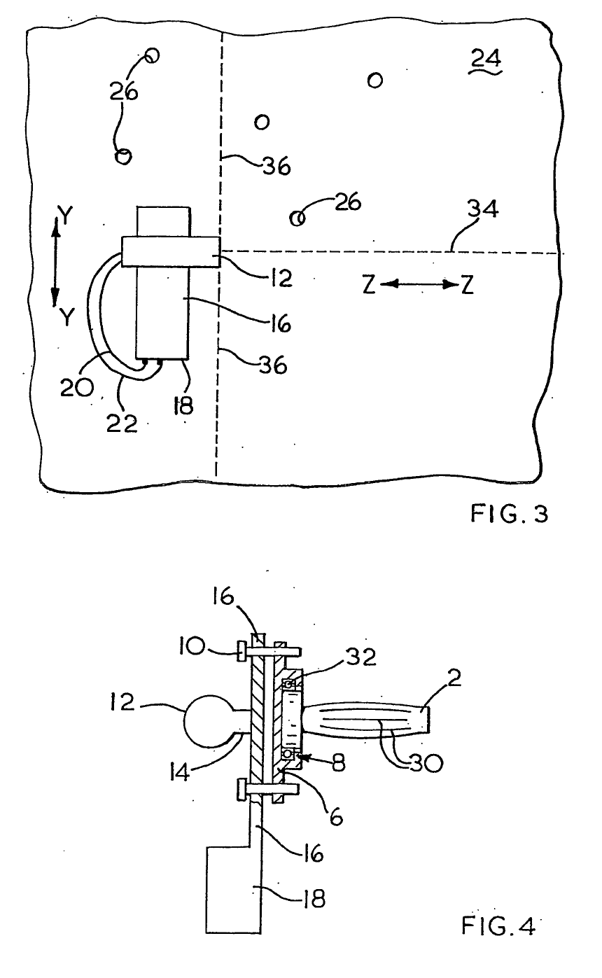

FIG. 3 shows an elevation view of a workpiece to which the device of FIGS. 1 and 2 is mounted and hangs vertically downwards;

FIG. 4 shows a schematic view along the line X-X of FIG. 2;

FIG. 5 shows a schematic illustration of a power tool including the device of FIGS. 1 and 2;

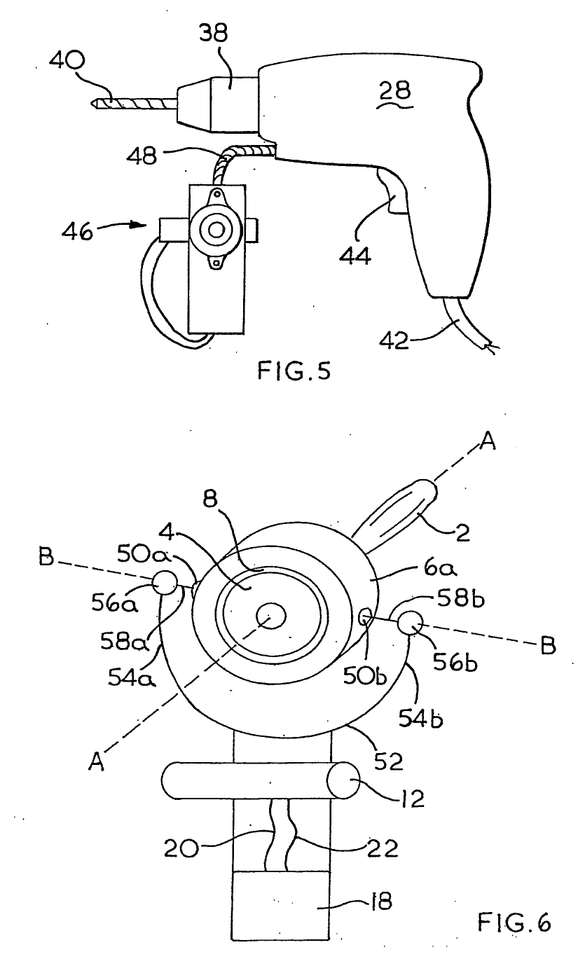

FIG. 6 shows a perspective view of a device of a second embodiment of the present invention;

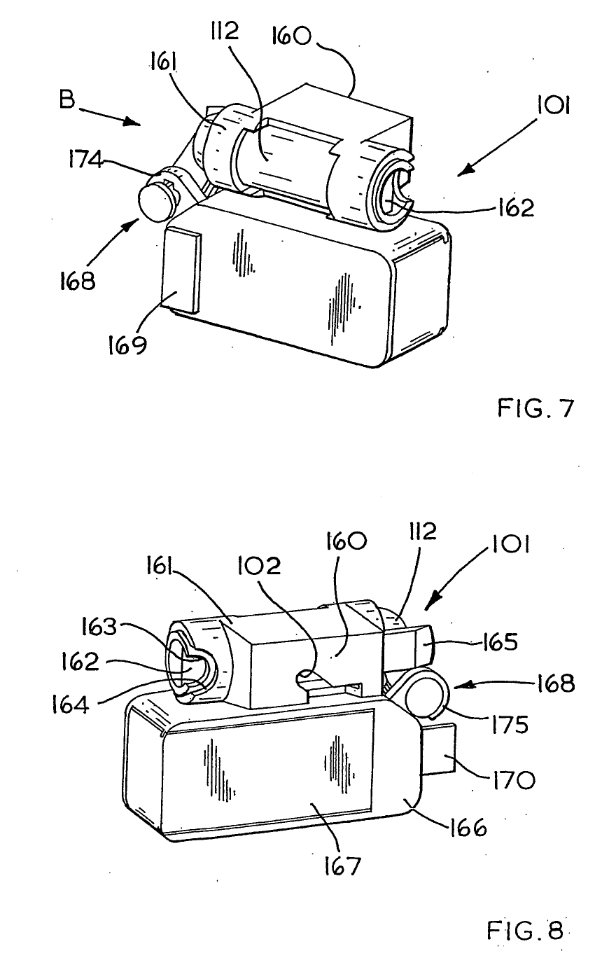

FIG. 7 is a perspective front view of a device of third embodiment of the present invention in a first equilibrium condition thereof;

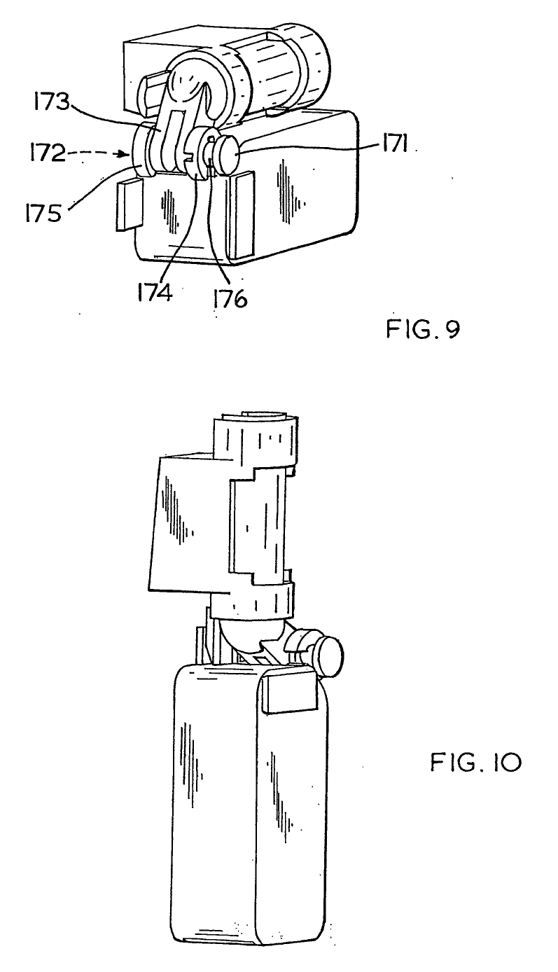

FIG. 8 is a rear perspective view of the device of FIG. 7;

FIG. 9 is a perspective view along the direction of arrow B in FIG. 7;

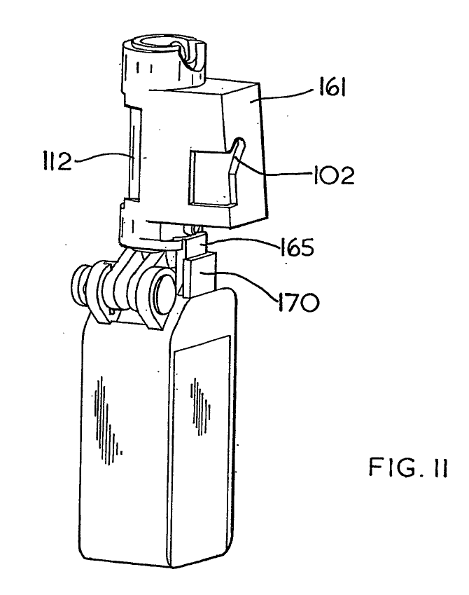

FIG. 10 is a perspective front view of the device of FIG. 7 in a second equilibrium condition thereof; and

FIG. 11 is a rear perspective view of the device of FIG. 10.

Referring firstly to FIGS. 1 and 2, it can be seen that the device in accordance with the present invention comprises a mount (2) which, in this example, is chosen to be able to fit into a hole drilled by a drill bit or the like. Of course, instead of the mount (2) being a cylindrical projection as shown in the figures, it is possible for this mount to take any suitable shape or configuration so that it may fit into the appropriately shaped hole, cut, rebate, channel etc. formed in a workpiece to which the device is to be mounted.

Coupled to the mount (2) is a circular disc (4) which is itself formed within a plastics retaining member (6) via a ball race mechanism (8). The ball bearings of the ball race (8) cannot be seen from FIGS. 1 and 2 but they are visible in the FIG. 4 cross section.

The plastics disc (4) is coupled to the mount (2) and is rotatably fixed thereto. Because the retaining member (6) is coupled to the plastics disc (4) via the ball race (8) then the plastics disc (4) may freely rotate within the retaining member (6) via the ball race (8).

Rigidly coupled to the retaining member (6) via mounting pins (10) is a projector, in this example laser emitter (12). The laser (12) is rigidly coupled via a couple (14) to mounting bracket (16). At its lower end the mounting bracket (16) supports (in this case is integrally formed therewith) a battery (18). The positive (20) and negative (22) terminals of the battery are shown in the Figures because they supply power from the battery (18) to the laser (12).

The position of the laser emitted (12) is adjustable, in a direction perpendicular to the axis of mount (2), by means of a screw thread (90) and thumbwheel (91). This enables the laser emitter to be moved off the axis of mount (2) in the case of the mount being located in a non-horizontal hole in the workpiece, so that the laser emitter (12) is located generally horizontally forwards of where the mount enters the surface of the workpiece, even when the longitudinal axis of the mount does not extend horizontally.

Because the laser (12) is rigidly coupled to the mounting bracket (16) via the couple (14) and also because the mounting bracket (16) is rigidly coupled to the retaining member (6) via the mounting pins (10), then it can be seen that the laser (12) may freely rotate about the mount (2) by virtue of the ball race (8). However, because the mounting bracket (16) is weighted by battery (18) the mass of which is deliberately greater than the mass of the remainder of the mounting bracket (16) then the mounting bracket (16) acts as a pendulum under the influence of gravity so that it will come to rest at its lowest point and therefore ensure that this rest position is constant under the force of gravity. By aligning the laser (12) in a known relationship relative to the mounting bracket (16) then the attitude of the laser (12) to the horizontal will be known at any stage where the battery (18) comes to rest under the action of gravity following its pendulum oscillation where allowed to move freely and the device is held in a stable position via the mount (2). Referring now also to FIGS. 3 and 4 it is shown how the device operates in use. A workpiece (24), in this example a horizontal wall, has a plurality of holes (26) drilled therein via a conventional drill such as drill (28) shown in FIG. 5.

In FIG. 3 the device is mounted in one such hole (26) although this cannot be seen from the Figure because the device obscures the hole (26).

In the example shown the mount (2) is chosen to be a cylindrical projection and is formed from resilient plastics material which has a plurality of longitudinally extending slits (30) formed therein, so that in its rest position the external periphery of the mount (2) forms an oval shape such that the diameter thereof in a central region where the slits (30) exist is greater than at the extremes thereof. In this way once the mount (2) is forced into a suitably dimensioned hole (26) then the resilience of the mount (2) achieved by the slits (30) allows the mount to contract slightly within the hole (26) and thereby form a tight fit therein. Of course it will be appreciated that any form of resilient character will be efficacious for the mount (2) to operate. For example, the mount (2) may be formed from an expandable foam-type material which is initially compressed in order to be able to fit within the hole (26) and then expands within the hole in order to take up a central position located therein. Alternatively the mount may be, for example, an inflatable balloon-type structure which is inserted into the hole and is then pumped with air to expand to fit centrally within the hole. Any form of variant such as that listed above will be adequate to work within the scope of this invention.

The mount (2) is, therefore, semi-rigidly mounted within its respective hole (26). As can be seen from FIG. 4 the ball race (8) includes a plurality of ball bearings (32) which, in this example at least, allow for free rotation between the plastics disc (4) and retaining member (6). This effectively, means that there is free rotation between the mount (2) and the mounting brackets (16) and hence the laser (12).

Thus, once the mount has been placed into its respective hole (26) and allowed to be free of any other external forces, the pendulum action due to gravitational force acting upon the relatively heavy battery (18) compared to the remainder of the mounting bracket (16) means that the mounting bracket (16) will perform a to and fro oscillating motion whose amplitude is ever decreasing until it comes to a rest in a vertical position. Of course, it is feasible for the device to be damped to quickly bring the oscillations to a minimum and this may be achieved in numerous ways, the most effective one of which being increasing the size of the ball bearings (32) within the ball race (8) so that an under-damped system is not possible to be achieved.

Referring particularly to FIG. 3 it can be seen that the device is in a vertical plane as shown by the line Y-Y and that the laser (12) has been chosen to emit its alignment guide along both the vertical plane Y-Y and also the horizontal plane Z-Z.

In the present example the alignment guide which emanates from the laser (12) has been chosen to be visible and comprises a first, in this case horizontal, beam of light (34) and a second, in this case vertical, beam of light (36). It will, of course, be apparent to those skilled in the art that any suitable alignment guide may be projected by the laser (12), the only important feature to note here that the entire device takes its reference point from the vertical Y-Y but from this point any suitable alignment guide may be emitted. Whilst in the above example a beam of light has been chosen to emanate from the laser (12) it is equally efficacious with the present invention for a plane of light to emanate. Thus, for example, when the laser (12) is emitting a plane of light on a workpiece which happens to be a wall which is curved, the plane may be visible from different parts of the curved wall. Such would not be the case, for example, if the wall were perfectly straight, because a beam of light would not be able to cover projections mounted on the wall. Thus there are certain instances in which a plane of light is by far the best type of alignment guide to emanate from the laser (12).

In the present circumstances where the invention is readily envisaged to be used with power tools, it is more usual that the alignment guide (34, 36) will actually comprise a simple horizontal line (in this case 34) and most probably will comprise a visible beam of laser light whose wavelength provides for a red light which is clearly visible by a user.

Instead of a simple horizontal line (34) being emitted or indeed a simple vertical line (36) being emitted by the laser (12) cross wires or other lines or grids etc. are equally possible. Of course the complexity of the laser used mainly to be altered from a simple laser as shown in the drawings, but this is simply a matter of choice.

In the example shown, if the user is, for example, wishing to drill a further hole (26) aligned with that particular hole in which the device is mounted as shown in FIG. 3, and the further hole needs to be horizontally aligned therewith, it is simply a matter of marking a position on the workpiece (24) along the line (34) and then drilling a further hole at this particular point.

Reference now also to FIG. 5 shows a kit of parts suitable for use with the present invention which comprises, a power tool, in this case an electric drill (28) of conventional design with a chuck (38) for mounting a drill bit (40) therewithin. Power is supplied via mains power cable (42) to the drill which is actuated by means of trigger (44). All this is conventional in the art.

It can be seen that the alignment device shown generally as (46) in FIG. 5 is coupled to the body of the drill (28) via a flexible cord (48). It is possible for the flexible cord (48) to be withdrawn a considerable distance from the drill (28) and the cord (48) to be spring loaded so that it returns within the body of the drill (28) so that the device (46) somehow locks either to the outside or the inside of the drill (28). The method by which this is achieved is not germane to the present invention so will not be described any more herein.

By reference now to FIG. 6 an alternative embodiment of the present invention will be described. In this FIG. 6, similar components to those of FIGS. 1-5 bear corresponding reference numerals.

It can be seen from FIG. 6 that the mount (2) is coupled to a retaining member 6a via a central plastics disc (4) and ball race (8) as in the embodiment shown in FIGS. 1-5. Although the geometry of the embodiment of FIG. 6 is different to that of FIGS. 1-5 the function of the above components is identical.

The retaining member (6a) is cylindrical and the ball race (8) is formed around the central plastics disc (4) so that the outer portion (6a) of the retaining member may freely rotate about the central plastics disc (4) and about the axis A-A. This is in common with the embodiments of FIGS. 1-5.

Two pivot points (50a) and (50b) are diametrically opposed to one another about the peripheral circumference of the retaining member (6a). The pivot points (50a) and/or (50b) may be simple indentations in the surface of the retaining member (6a), or they could be further ball races. The purpose, in either case, though, is to enable the retaining member (6a) to be articulated to a supporting yoke (52).

The supporting yoke (52) has two extending arms (54a) and (54b) each of which terminates at a support member (56a) and (56b) respectively. Protruding from each support member (56a, 56b) and extending along an axis B-B inwardly toward the retaining member (6a), are respective mounting arms (58a, 58b). The ends of the arms (58a, 58b) remote from their respective support members (56a, 56b) are in operative engagement with the pivot points (50a, 50b). This enables free rotation of the retaining member 6a about the axis B-B.

It will be appreciated that as the retaining member (6a) is free to rotate independently about two orthogonal axes A-A and B-B, the structure shown in FIG. 6 acts as a gimbal. Thus, under the influence of the lower weight in the form of the battery (18), the gimbal structure of FIG. 6 will always settle under the influence of gravity such that the axis B-B is horizontal. This will broadly be the case whatever the attitude or angle of the axis A-A to the horizontal, but not including extreme angles at which the frictional forces on the bearings can resist the forces of gravity.

The above gimbal structure can have advantage if the user drills, for example, a first hole (26) in a vertical workpiece and this hole does not extend parallel to the horizontal. The gimbal structure enables the device to still function and be able to pivot freely about a horizontal axis to the free pivoting of the retaining member (6a) about the axis B-B. This, in effect, compensates for the axis A-A not being horizontal. If the axis A-A of the mount (2) were not horizontal in the embodiments of FIGS. 1 - 5, then this might hinder the free pendulum action of the device. This shortcoming is alleviated with the embodiment of FIG. 6.

It will be appreciated that the device illustrated in FIG. 6 could function if only one mounting arm (58a) or (58b) were used to couple the yoke (52) to the retaining member (6a).

A particular advantage is associated with having a device (46) detachably secured to a drill (28) in this manner. For example, it is possible for a user to drill into a workpiece using a drill bit (40) and then apply the device (46) to the hole so drilled whilst allowing for the flexible cord (48) to be extended so that the drill can be used to drill the subsequent hole whilst the device (46) is in place in the first hole.

Referring to FIGS. 7 to 9, in which parts common to the embodiment of FIGS. 1 to 5 are denoted by like reference numerals but increased by 100, a projection device (101) for producing vertical and horizontal alignment guides comprises a mount (102) in the form of an elongate, inclined slot provided in a rear face (160) of a first body part (161) of the device. The first body part (161) can be made of any suitable material, such as durable plastics or metal. The slot (102) enables the device (101) to be mounted to an existing mount in the workpiece (not shown), such as a screw, nail or hook, so that the device (101) can pivot about the existing mount (not shown).

A projector (112) contains a laser emitter (not shown) which is arranged adjacent slot (102). The projector (112) emits a laser beam via lens (162) and has a cylindrical external surface and is accommodated within a cylindrical part of the first body part (161) such that a limited amount of rotation of the projector (112) relative to the first body part (161) about the longitudinal axis of the projector (112) is possible. The rear face (160) of first body part (161) is inclined slightly relative to the axis of projector (112) so that when the slot (102) is mounted to an existing fixing so that the rear face (160) abuts the workpiece, the laser beam is projected onto the workpiece at a location spaced from the slot (102).

The projector (112) and first body part (161) are provided with semicircular cutouts (163), (164) to increase the visibility of the laser beam emitted by the projector. The first body part (161) is also provided, at the end thereof remote from the lens (162), with an abutment rib (165), the purpose and operation of which will be described in greater detail below.

A second body part (166) has a chamber, closed by a cover (167), to accommodate a battery (not shown) for supplying electrical power to the projector (112). The second body part (166), which will generally be constructed from the same material as the first body part (161), is connected to the first body part (161) by means of a lockable pivot mechanism (168). The device (101) is arranged such that when the first and second body parts (161), (166) are locked relative to each other in the position shown in FIGS. 7 to 9 with a battery contained in the chamber of second body part (166), and the slot (102) is mounted to a fixing on the workpiece, the device (102) comes to rest with its centre of gravity directly below the slot (102)and the laser beam projected horizontally. In this way, the device (102) projects a horizontal laser beam onto the workpiece, with the laser emitter located on the axis about which the device (102) pivots relative to the workpiece. The second body part (166) is also provided with a switch (169) for switching electrical power to the laser emitter, and an abutment rib (170), the function of which will be described in greater detail below, opposite the abutment rib (165) of the first body part (161).

The lockable pivot mechanism (168) comprises a pair of outwardly pointing projections (171), (172) provided on opposite sides of a bifurcated part (173) of the rear part of the projector (112), the projections (171), (172) being received within corresponding apertured parts (174), (175) respectively provided on second body part (166). The projection (171) has a portion (176) of generally cross-shaped cross-section and a portion of generally circular cross-section (not shown) adjacent to portion (176). The aperture provided in part (174) has a generally circular inner periphery, but also has recesses (not shown) outwardly of the circular inner periphery corresponding to the cross-shaped portion (176). The projection (171) is axially displaceable relative to part (174) to bring the cross-shaped portion (176) into engagement with the aperture on part (174) to prevent the projection (171) rotating within the aperture, or to bring the portion of circular cross section into engagement with the aperture to allow the projection (171) to rotate within the aperture. In this way, by axially displacing projection (171) relative to part (174), the first (161) and second (166) body parts can be locked relative to each other in the orientation shown in FIGS. 7 to 9.

Referring now to FIGS. 10 and 11, when the first (161) and second (166) body parts are pivoted relative to each other about pivot mechanism (168) through approximately 180E from the orientation shown in FIGS. 7 to 9, they can also be locked relative to each other in the orientation shown in FIGS. 10 and 11, by axially displacing projection (171) relative to part (174). The projector (112) can rotate relative to the first body part (161) until the abutment ribs (165), (170) come into contact with each other as shown in FIGS. 10 and 11. In this position, when the device (101) containing a battery is mounted by slot (102) to a fixing on the workpiece, the device (101) comes to rest with the laser beam being projected vertically and the laser emitter being located on the axis about which the device (101) pivots relative to the workpiece.

The operation of the embodiment of FIGS. 7 to 11 will now be described.

In order to provide a hole in the workpiece which is horizontally aligned with a first fixing, the device (101) is mounted to the workpiece by first locking the first (161) and second (166) body parts in the relative orientation shown in FIGS. 7 to 9 and mounting the slot (102) to the existing fixing. In this relative orientation, the device (101) can pivot relative to the workpiece and comes to rest with the laser beam projected horizontally and the laser emitter located on the pivot axis. Because of the angle of inclination of the rear face (160) of first body part (161), therefore, the laser beam is projected onto the workpiece at a location spaced from the first fixing.

In order to locate a position vertically aligned with the fixing to which slot (102) is mounted, projection (171) is displaced axially relative to part (174) so that the first (161) and second (166) body parts can be pivoted through 180E relative to each other about pivot mechanism (168). The projection (171) is then axially displaced in the opposite direction relative to part (174) to lock the two body parts (161), (166) in position relative to each other in the arrangement in FIGS. 10 and 11. The first body part (161) is then pivoted about projector (112) until the abutment ribs (165), (170) come into contact with each other. When the device (101) is then mounted to the existing fixing by mounting the slot (102) to the fixing, the device (101) pivots relative to the workpiece and comes to rest with the laser beam being projected vertically and the laser emitter located on the pivot axis. Again, because of the angle of inclination of the rear face (160) of first body part (161), the laser beam is projected onto the workpiece at a location spaced from the slot (102).

It will be appreciated by persons skilled in the art that the above embodiments have been described by way of example only, and not in any limitative sense, and that various alterations and modifications are possible without departure from the scope of the invention as defined by the appended claims. For example, each of the embodiments may be provided with adjustment means such as the screw thread (90) and thumbwheel (91) of FIG. 1, and the adjustment means can be constructed in a wide variety of different forms, for adjusting the laser emitter off the axis of rotation of the emitter about the mount.

1. A device for projecting an alignment guide onto a workpiece, the device comprising:
a mount for mounting the device to the workpiece, upon which workpiece the device is to project the alignment guide; and
a self-levelling projector for projecting the alignment guide onto the workpiece in a predetermined orientation relative to the vertical;
the device characterised in that the projector is articulated to the mount in use so that the alignment guide emanates from a point adjacent a substantially horizontal line extending outwards of and through the location on the surface of the workpiece where the mount is situated.

2. A device according to claim 1, wherein the projector is articulated to the mount in use so that the alignment guide emanates from that point on the workpiece where the mount is situated.

3. A device according to claim 1 or 2, wherein the projector is adapted to self-level in a plurality of equilibrium conditions.

4. A device according to claim 3, further comprising a support for the projector, wherein the support is adapted to receive the projector in a plurality of orientations.

5. A device according to claim 3, further comprising a first body part for supporting the projector and a second body part adapted to engage the first body part in first and second orientations relative thereto to define respective first and second equilibrium conditions.

6. A device according to claim 5, further comprising locking means for locking said first and second body parts relative to each other in said first and second orientations.

7. A device according to claim 6, wherein the first and second body parts are pivotable relative to each other about a first axis between said first and second orientations.

8. A device according to claim 6 or 7, wherein the locking means comprises at least one first pivot part provided on one of said first or second body part, and at least one second pivot part provided on the other of said first or second body part, wherein at least one said first pivot part is adapted to be displaced relative to at least one said second pivot part in a direction substantially parallel to said first axis between an unlocked condition in which said first and second body parts are pivotable relative to each other about said first axis, and a locked condition in which said first and second body parts are prevented from pivoting relative to each other.

9. A device according to claim 8, wherein the first pivot part comprises a pin having a first portion of substantially circular cross section, and a second portion of non-circular cross section, wherein the second portion is adapted to engage a non-circular aperture in a said second pivot part in the locked condition.

10. A device according to claim 9, wherein said second portion is of cross-shaped cross section.

11. A device according to any one of claims 8 to 10, wherein the first and second body parts are pivotable relative to each other about a second axis, transverse to said first axis, and the device further comprises engaging means for enabling alignment of said first and second body parts in a predetermined orientation relative to each other.

12. A device according to claim 11, wherein the engaging means comprises at least one respective abutment member provided on said first and/or second body part for engaging the other of said first or second body part.

13. A device according to any one of claims 5 to 12, wherein the second body part is adapted to accommodate a battery for supplying electrical power to the projector.

14. A device according to any one of the preceding claims, further comprising adjustment means for adjusting the position of the projector relative to the axis of articulation thereof to the mount.

15. A device according to claim 14, wherein the adjustment means includes a screw thread.

16. A device according to any one of the preceding claims, wherein the projector is adapted to self-level under the influence of gravity.

17. A device according to claim 16, wherein the projector is adapted to act like a pendulum in order to self-level.

18. A device according to claim 17, wherein the action of the pendulum is damped in order to prevent excess oscillation.

19. A device according to any one of the preceding claims, wherein the projector is freely rotatable about the mount.

20. A device according to claim 19, wherein the projector is articulated to the mount via a ball race bearing assembly.

21. A device according to any one of the preceding claims, wherein the projector includes a laser emitter.

22. A device according to any one of the preceding claims, wherein the alignment guide comprises a visible line, lines, cross wires or a grid.

23. A device according to any one of the preceding claims, wherein the alignment guide is adapted to provide a reference point on the workpiece which is substantially horizontally or vertically aligned with that position on the workpiece where the mount is situated.

24. A device according to any one of the preceding claims, wherein the mount comprises a generally cylindrical projection which is resiliently radially expandable or contractable.

25. A device according to any one of the preceding claims, wherein the projector is pivotably mounted to the mount about a third axis substantially perpendicular to the axis of articulation thereof to the mount.

26. A device according to any one of the preceding claims, wherein the mount comprises an aperture for engaging an existing fixing on the workpiece.

27. A device for projecting an alignment guide onto a workpiece, the device substantially as hereinbefore described with reference to the accompanying drawings.

28. A kit of parts for enabling a plurality of aligned holes, cuts or rebates to be formed within a workpiece, the kit of parts comprising:
i) a power tool for forming an initial hole cut or rebate in the workpiece, and;
ii) a device for projecting an alignment guide onto a workpiece, the device comprising:
a mount adapted to be mounted to a workpiece; and
a self-levelling projector for projecting the alignment guide onto the workpiece in a predetermined orientation relative to the vertical;
the device characterised in that the projector is articulated to the mount in use so that the alignment guide emanates from a point adjacent a substantially horizontal line extending outwards of and through the location on the surface of the workpiece where the mount is situated.

29. A kit of parts according to claim 28, wherein the projecting device is removably retained on or contained within the power tool.

30. A kit of parts for enabling a plurality of aligned holes, cuts or rebates to be formed within a workpiece, the kit of parts substantially as hereinbefore described with reference to FIG. 5 of the accompanying drawings.

31. A method for projecting a self-levelling alignment guide onto a workpiece, the method comprising the steps of:
fitting a mount within a cut, hole or rebate, or attaching the mount to a projection, which mount is articulated to a self-levelling projector; and
projecting, from the self-levelling projector, an alignment guide onto the workpiece; which alignment guide is projected onto the workpiece in a predetermined orientation relative to the vertical.

32. A method according to claim 31, further comprising the step of forming said hole, cut or rebate within the workpiece, or attaching a projection thereto.

33. A method for projecting a self-levelling alignment guide onto a workpiece, the method substantially as hereinbefore described with reference to the accompanying drawings.
